(19) United States
(12) Patent Application Publication
(10) Pub. No.: US 2013/0308248 A1
(43) Pub. Date: Nov. 21, 2013

(54) MAGNETICALLY MODIFIED MANGANESE DIOXIDE ELECTRODES FOR ASYMMETRIC SUPERCAPACITORS

(71) Applicant: The University of Iowa Research Fundation, (US)

(72) Inventors: Johna LEDDY, Iowa City, IA (US); Garett G. W. LEE, Salt Lake City, UT (US)

(73) Assignee: The University of Iowa Research Fundation, Iowa City, IA (US)

(21) Appl. No.: 13/888,284

(22) Filed: May 6, 2013

Related U.S. Application Data
(60) Provisional application No. 61/643,841, filed on May 7, 2012.

(51) Int. Cl. H01G 11/46

(52) U.S. Cl. CPC H01G 11/46
USPC 361/502; 29/25.03

(57) ABSTRACT

A supercapacitor, in particular an asymmetric supercapacitor, comprising an electrode, wherein the electrode is magnetically modified and comprises MnO₂. The electrode can comprise a mixture comprising MnO₂ and at least one magnetic material, wherein the magnetic material comprises SmCo₅. The supercapacitor can also comprise an aqueous electrolyte having a pH of 5-9. The electrode serves in the asymmetric supercapacitor through pseudocapacitance. Higher capacitance and efficiency can be observed.

### RELATED APPLICATIONS

This application claims priority to U.S. provisional application 61/643,841 filed May 7, 2012 which is incorporated herein by reference.

### FEDERAL FUNDING STATEMENT

This invention was made with government support under Contract No. 09-1-T6.01-9988 JSC awarded by the National Aeronautics and Space Administration. The Government has certain rights in the invention.

### BACKGROUND

Manganese dioxide (MnO₂) is an abundant, naturally occurring oxide of manganese that is used ubiquitously in primary alkaline batteries. MnO₂ is a complex material, existing as several polymorphs, each with unique properties. Recently, investigators have utilized α-MnO₂ as the active material for asymmetric electrochemical capacitors (i.e., ultracapacitors or supercapacitors). See Brousse et al., J. Electrochem. Soc. 151:A614-A622 (2002); Kim et al., J. Electrochem. Soc. 150:D56-D62 (2003). See also, for example, U.S. Pat. No. 7,576,971. However, the chemical reactions of MnO₂ involved with a supercapacitor versus with a battery are different. Note that for purposes herein MnO₂ includes stoichiometric mixtures of MnO₂ so the ratio of Mn and O may not be precisely 1:2, but could include 1.9, for example.

Supercapacitors are systems that store charge electrostatically in the electrochemical double layer (EDLC), and faradaically via reversible charge transfer reactions. This places supercapacitors between traditional electrostatic capacitors and batteries in the power density/energy density hierarchy. See Electrochemical Capacitors. B. E. Conway. Kluwer Academic/Plenum Pub., New York (1999).

The best supercapacitor material thus far identified is RuO₂, which produces specific capacitances (−600 F/g); however, material costs limits RuO₂ use. MnO₂, on the other hand, promises a cheaper solution, with specific capacitances of 100-200 F/g for powder-based electrodes already achieved. Additionally, MnO₂ can be used in neutral aqueous systems to limit cost and environmental hazard.

Thus, a need exists for MnO₂-based electrodes with improved capacitance for use in, for example, supercapacitors and asymmetric supercapacitors.

### SUMMARY

Embodiments described herein include devices and compositions, and methods of making and using such devices and compositions.

Disclosed here is a supercapacitor comprising an electrode, wherein the electrode is magnetically-modified and comprises MnO₂.

In one embodiment, the supercapacitor is an asymmetric supercapacitor. In one embodiment, the supercapacitor is an asymmetric supercapacitor comprising said electrode as cathode.

In one embodiment, the supercapacitor is an asymmetric supercapacitor comprising said electrode as cathode, and wherein said electrode is in contact with an aqueous electrolyte having a pH of 5-9. In one embodiment, the supercapacitor is an asymmetric supercapacitor comprising said electrode as cathode, and wherein said electrode is in contact with an aqueous electrolyte selected from CaCl₂, KCl, K₂SO₄, and NaCl. In another embodiment, the supercapacitor is an asymmetric supercapacitor comprising said electrode as cathode, and wherein said electrode is in contact with a non-aqueous electrolyte.

In one embodiment, the supercapacitor is an asymmetric supercapacitor comprising a counter electrode which comprises carbon-based material.

In one embodiment, said MnO₂ is selected from γ-MnO₂, β-MnO₂, α-MnO₂, and a mixture thereof.

In one embodiment, the electrode comprises a mixture comprising MnO₂ and at least one magnetic material. In one embodiment, the electrode comprises a mixture comprising MnO₂ and at least one magnetic material, wherein said magnetic material comprises SmCu5.

In one embodiment, the electrode comprises a mixture comprising MnO₂, at least one magnetic material, and at least one binder. In one embodiment, the electrode comprises a mixture comprising MnO₂, at least one magnetic material, and at least one binder, and wherein said binder comprises polytetrafluoroethylene.

In one embodiment, the electrode comprises a mixture comprising MnO₂, at least one magnetic material, and at least one conductor. In one embodiment, the electrode comprises a mixture comprising MnO₂, at least one magnetic material, and at least one conductor, and wherein said conductor comprises graphite.

In one embodiment, the electrode comprises a mixture comprising MnO₂, at least one magnetic material, at least one binder, and at least one conductor. In one embodiment, the electrode comprises a mixture comprising MnO₂, SmCo₅, polytetrafluoroethylene, and graphite.

In one embodiment, the electrode comprises 50-75 wt. % of MnO₂. In one embodiment, the electrode comprises 1-20 wt. % of a magnetic material. In one embodiment, the electrode further comprises 10-30 wt. % of a conductor material. In one embodiment, the electrode further comprises 0.5-10 wt. % of a binder material.

In one embodiment, the magnetically modified MnO₂ is present in the form of a thin film having a thickness of 0.1-500 μm. In another embodiment, the magnetically modified MnO₂ is present in the form of a thin film having a thickness of 0.2-100 μm.

In one embodiment, the supercapacitor has an increase in capacitance of at least 10%, compared to a control supercapacitor comprising an electrode that comprises an analogous MnO₂ composition except there are no magnetic additives. In another embodiment, the supercapacitor has an increase in capacitance of at least 30%, compared to a control supercapacitor comprising an electrode that comprises an analogous MnO₂ composition except there are no magnetic additives.

In one embodiment, the supercapacitor does not comprise aqueous KOH as electrolyte.

Also disclosed is a method for making the supercapacitor described herein, comprising incorporating an electrode that is magnetically-modified and comprises MnO₂ as cathode of the supercapacitor. In one embodiment, the method further comprising incorporating an aqueous electrolyte having a pH of 5-9.

Further disclosed is a method for using the supercapacitor described herein, comprising charging and discharging the supercapacitor. In one embodiment, the MnO₂ is reduced at the surface of the electrode with electrolyte cation neutralization during charging and returns to MnO₂ during the discharge cycle. In one embodiment, no more than 10% of the MnO₂ in the bulk of the electrode is reduced.

At least one advantage of at least some embodiments disclosed herein is higher specific capacitance of the supercapacitor comprising magnetically-modified MnO₂ electrode.

At least one other advantage of at least some embodiments disclosed herein is higher energy and/or power densities of the supercapacitor comprising magnetically-modified MnO₂ electrode.

At least one other advantage of at least some embodiments disclosed herein is improved rates of charge and discharge of the supercapacitor.

At least one other advantage is that the impact of magnetic modification is sustained across multiple charge and discharge cycles.

At least one other advantage of at least some embodiments disclosed herein is improved faradaic processes in magnetically-modified MnO₂ electrode, where the efficiency of the faradaic electron transfer (ET) reaction at the MnO₂ solution interface and between neighboring chemical species is enhanced.

### BRIEF DESCRIPTION OF THE DRAWINGS

FIG. 1 shows one exemplary embodiment of the asymmetric supercapacitor described herein.

FIG. 2 shows (A) SEM image of untreated MnO₂ (EMD), scale bar is 30 microns, and (B) SEM image of untreated SmCo₅, average particle size 14.9±18.4 μm (n=36).

FIG. 3 shows an exemplary half-cell assembly in 0.1M CaCl₂ (aq.) bath.

FIG. 4 shows initial charging/discharging of EMD half-cells, unmodified versus 5% SmCo₅ modified.

FIG. 5 shows the “saw-tooth” pattern of modified electrodes cycled at 1 mA charge/discharge current.

FIG. 6 shows the double-reciprocal plot of 1/E-drop (V⁻¹) versus 1/i (A⁻¹) for unmodified and % SmCo₅ modified EMD half-cells.

FIG. 7 shows the magnetic loading impact at 1 mA charging/discharging currents.

FIG. 8 shows the magnetic loading impact at 2.5 mA charging/discharging currents.

FIG. 9 shows one exemplary embodiment of the magnetically-modified MnO₂ electrode described herein, wherein MnO₂ (particle, darkened circles) is mixed with the magnetic material (particle, open circles).

FIG. 10 shows one exemplary embodiment of the magnetically-modified MnO₂ electrode described herein, wherein MnO₂ is present in the substrate (which is in contact with the current collector), and the magnetic material is present in the coating (which is in contact with the electrolyte solution).

FIG. 11 shows one exemplary embodiment of the magnetically-modified MnO₂ electrode described herein, wherein the magnetic material is present in the substrate (which is in contact with the current collector), and MnO₂ is present in the coating (which is in contact with the electrolyte solution).

### DETAILED DESCRIPTION

### Introduction

All references described herein are hereby incorporated by reference in their entireties.

Disclosed herein are magnetically modified MnO₂ electrodes for applications in electrochemical power sources, including supercapacitors, in particular asymmetrical supercapacitors. A supercapacitor is an electrochemical device that stores electrical power by two mechanisms, faradaically and nonfaradaically. It is functionally known in the art to be distinct from and non-equivalent to a battery. Nonfaradaic charge storage occurs electrostatically in the chemical double layer (EDLC). Faradaic charge storage occurs when an electron is transferred from one species to another. More specifically, the electron is transferred from a solution based cation (positively charged ion) to the MnO₂ in a reductive process. The cation is specifically adsorbed to the electrode surface (i.e., an adatom). This process in an aqueous system is shown in the following chemical Equation 1 for a monocation. Analogous reactions are apparent for polycations.:

(MnO₂)_{surface}+M⁺+e⁻ [symbol] (MnO₂⁻M⁺)_{surface} [1]

### Supercapacitor

Supercapacitors are electrochemical power devices. See, for example, U.S. Pat. No. 7,576,971 and US Patent Publication No. 2012/0300367. These devices fall between traditional electrostatic capacitors and batteries in the energy power hierarchy as displayed, for example on a Ragone plot. They have a higher power density and lower energy density than batteries. In supercapacitors, two mechanisms for charge storage exist: both nonfaradaic, electrostatic capacitance as in traditional electrochemical capacitors, and faradaic charge storage by a mechanism called pseudocapacitance. This faradaic mechanism involves a heterogeneous electron transfer between the metal oxide electrode to a solution based species that results in adsorbed surface charge.

Transition metal oxides, such as MnO₂ or RuO₂, allow this faradaic charge storage and are capable of capacitances of 100 to 200 F/gram for powder based electrodes, and 600 F/gram for thin films. It is demonstrated herein that magnetic fields increase pseudocapacitance at powder based MnO₂ electrodes. The increased capacitance is attributed to magnetic field effects on the faradaic component of the MnO₂ system because of an increase in the efficiency of the heterogeneous electron transfer. In one embodiment according to the working examples, the system was prepared as thin pellet, powder based composite electrodes.

The supercapacitor described herein can comprise, for example, an electrode which is magnetically-modified and comprises MnO₂. The supercapacitor can comprise the electrode which is magnetically-modified and comprises MnO₂ as cathode.

The supercapacitor described herein can comprise, for example, an aqueous electrolyte in contact with the electrode which is magnetically-modified and comprises MnO₂. The aqueous electrolyte can comprise, for example, an alkali metal cation or an alkaline earth metal cation. The aqueous electrolyte can have a pH of, for example, about 4-10, or about 5-9, or about 6-8, or about neutral. The aqueous electrolyte can comprise, for example, one of more of CaCl₂, KCl, K₂SO₄, and NaCl.

Alternative, the supercapacitor described herein can comprise, for example, a non-aqueous electrolyte in contact with the electrode which is magnetically-modified and comprises MnO₂. The non-aqueous electrolyte can comprise, for example, one or more carbonates such as propylene carbonate and ethylene carbonate.

In one embodiment, the supercapacitor described herein does not comprise KOH in the electrolyte. The simple strong electrolyte salts in water are less corrosive.

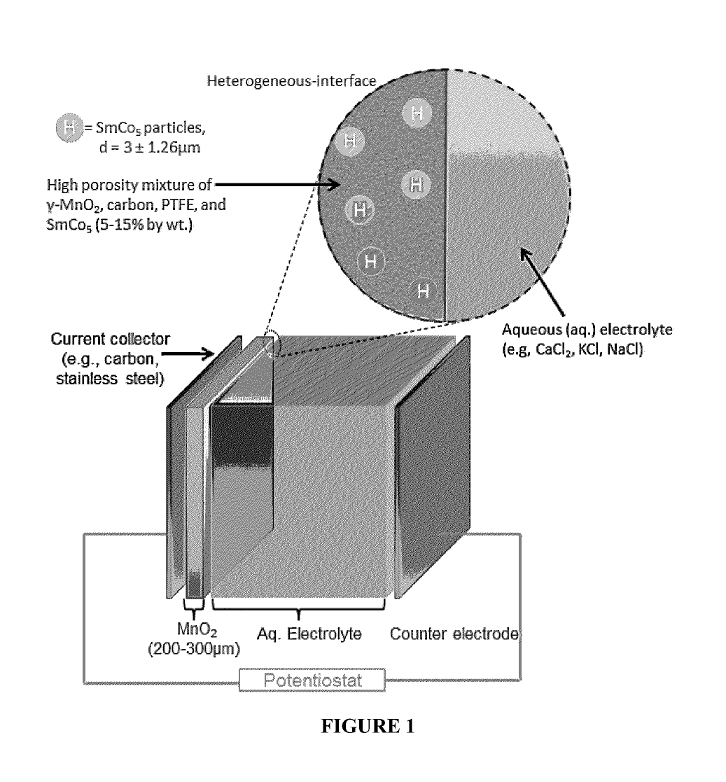

The supercapacitor described herein can be, for example, an asymmetric supercapacitor, as shown in FIG. 1. The asymmetric supercapacitor can comprise, for example, the electrode which is magnetically-modified and comprises MnO₂ as cathode. The asymmetric supercapacitor can comprise, for example, a counter electrode which comprises carbon-based material. In one embodiment, the supercapacitor described herein comprises a counter electrode comprising activated carbon. In other embodiments, the supercapacitor described herein comprises a counter electrode comprising at least one material selected from graphene, carbon nanotubes, carbon aerogel, polyacenes and conducting polymers, tunable nanoporous carbon (carbide-derived carbon), solid activated carbon or consolidated amorphous carbon, mineral-based carbon, and polypyrroles and nanotube-impregnated papers.

Compared to a control supercapacitor wherein the electrode comprises unmodified MnO₂, the supercapacitor described herein can have an increase in capacitance of, for example, at least 10%, or at least 20%, or at least 30%, or at least 50%. The supercapacitor can have an increase in power of, for example, at least 10%, or at least 20%, or at least 30%, or at least 50%. The supercapacitor can have an increase in energy of, for example, at least 10%, or at least 20%, or at least 30%, or at least 50%. The supercapacitor can have an increase in rate of discharge of, for example, at least 10%, or at least 20%, or at least 30%, or at least 50%. The supercapacitor can have an increase in rate of charge of, for example, at least 10%, or at least 20%, or at least 30%, or at least 50%. The supercapacitor can have an increase in Coulombic efficiency of charge of, for example, at least 10%, or at least 20%, or at least 30%, or at least 50%.

### Magnetic Material

Magnetic materials described herein are known in the art and include, for example, materials that develop a magnetic moment following exposure to a strong magnetic field for a sufficient period of time. The magnetic material can comprise, for example, permanent magnetic materials, paramagnetic materials, superparamagnetic materials, ferromagnetic materials, ferrimagnetic materials, superconducting materials, anti-ferromagnetic materials, and combinations thereof.

In one embodiment, the magnetic material comprises at least one permanent magnetic material selected from, for example, samarium cobalt, neodynium-iron-boron, aluminum-nickel-cobalt, iron, iron oxide, cobalt, misch metal, ceramic magnets comprising ferrites such as barium ferrite and/or strontium ferrite, and mixtures thereof.

In one embodiment, the magnetic material comprises at least one paramagnetic material selected from, for example, aluminum, steel, copper, manganese, and mixtures thereof.

In one embodiment, the magnetic material comprises at least one ferromagnetic or ferrimagnetic or anti-ferromagnetic material selected from, for example, gadolinium, chromium, nickel, and iron, and mixtures thereof.

In one embodiment, a mixture of permanent magnetic materials and paramagnetic materials is used.

In one embodiment, the magnetic material comprises at least one ferromagnetic or ferromagnetic material selected from, for example, iron oxides, such as Fe₃O₄ and Fe₂O₃.

In one embodiment, the magnetic material comprises at least one ferromagnetic material selected from, for example, Ni—Fe alloys, iron, and combinations thereof.

In one embodiment, the magnetic material comprises at least one ferrimagnetic material selected from, for example, rare earth transition metals, ferrite, gadolinium, terbium, and dysprosium with at least one of Fe, Ni, Co, and a lanthanide and combinations thereof.

In one embodiment, the magnetic material comprises at least one superconducting composition comprising a suitable combination of, for example, niobium, titanium, yttrium barium copper oxide, thallium barium calcium copper oxide, and bismuth strontium calcium copper oxide.

In one embodiment, the magnetic material comprises at least one anti-ferromagnetic material selected from, for example, FeMn, IrMn, PtMn, PtPdMn, RuRhMn, and combinations thereof.

The magnetic material can comprise one or more compounds selected from, for example, SmCO₅, Fe₃O₄, Fe₂O₃, NdFeB alloys, Sm₂Co₁₇, Sm₂Co₇, La_{0.9}Sm_{0.1}Ni₂CO₃, Ti_{0.51}Zr_{0.49}V_{0.70}Ni_{1.18}Cr_{0.12}. In a particular embodiment, the magnetic material is SmCo₅.

The magnetic material can comprise, for example, magnetic particles. The magnetic particles can be, for example, uncoated. The magnetic particles can comprises, for example, a magnetic core and at least one protective coating. The protective coating can comprise, for example, at least one inert material.

Other than magnetic particles, the magnetic material can be in the form of any type of microstructure materials, such as magnetic wires and magnetic meshes. In general, the magnetic material should be a small permanent magnet that can be incorporated into the electrode described herein. They do not have to be particles.

The size of the magnetic particles are not particularly limited. The diameter of the magnetic particles can be, for example, 1 to 1000 microns, 1 to 100 microns, or 1 to 50 microns, or 1 to 20 microns, or 1 to 10 microns, or less than 1 micron. In some embodiment, the magnetic particles have a diameter of at least 1 micron or at least 0.5 micron to sustain a permanent magnetic field. In some embodiments, the magnetic particles are nanoparticles.

### Electrode Comprising Magnetically-Modified Manganese Dioxide

The supercapacitors described herein can comprise at least one electrode which is magnetically-modified and comprises MnO₂. MnO₂ is used in batteries and electrochemical capacitors. The material is environmentally safe, abundant (elementally, Mn is twelfth most), and above all, inexpensive. In primary cells, MnO₂ is employed in a highly basic medium (6 to 9 M KOH). In that system, the MnO₂ is the active component of the cathode, where it can undergo two sequential electron transfer reactions as

MnO₂+H₂O+e=MnOOH+OH⁻

MnOOH+H₂O+e=Mn(OH)₂+OH⁻

or equivalently in [7]:

2MnO₂+H₂O+2e=Mn₂O₃+2OH⁻ [7]

When the process is irreversible, the manganese oxides undergo morphological changes that prevent the system from recharging. Work by Tesene, J. P. Magnetically-Treated Electrolytic Manganese Dioxide in Alkaline Electrolyte, Thesis, The University of Iowa 2005, thoroughly reviews this process and the associated morphological changes.

In comparison, in an asymmetric supercapacitor, electrical power can be stored by faradaically charge storage via the mechanism of pseudocapacitance. Here, the electron is transferred from a solution based cation (positively charged ion) to the MnO₂ in a reductive process, wherein the cation is specifically adsorbed to the electrode surface. This reversible process is shown in [1]:

(MnO₂)_{surface}+M⁺e⁻ [symbol] (MnO₂⁻M⁺)_{surface} [1]

The MnO₂ comprised in the electrode can be selected from, for example, γ-MnO₂, β-MnO₂, α-MnO₂, and a mixture of polymorphs.

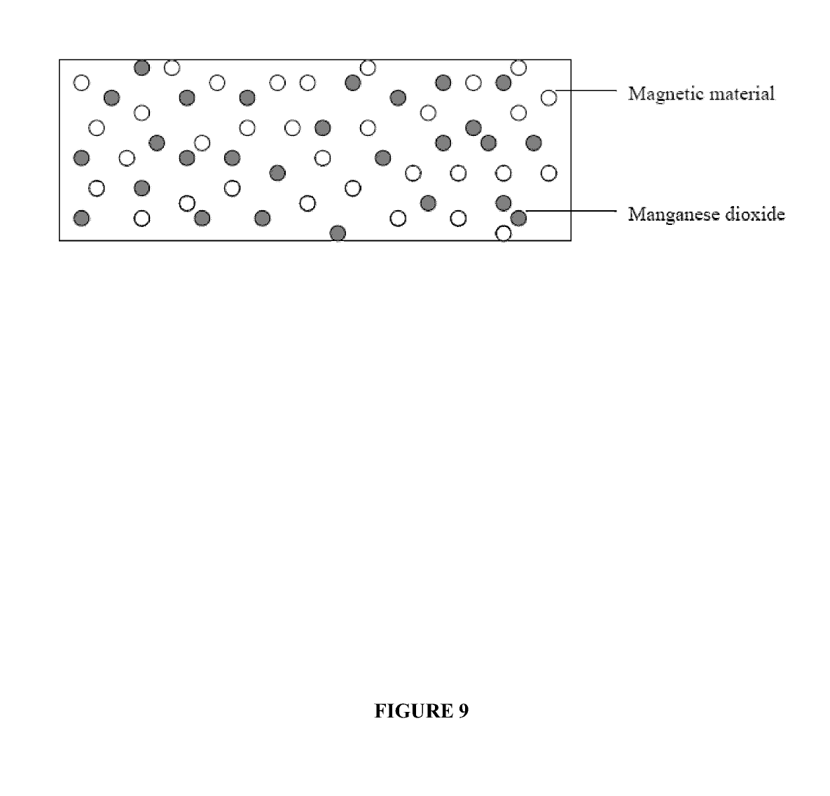

The electrode which is magnetically-modified and comprises MnO₂ described herein can comprise, for example, a mixture comprising MnO₂ and at least one magnetic material, as shown in FIG. 9. In some embodiments, the magnetically-modified MnO₂ electrode can comprise a mixture of MnO₂ and at least one magnet selected from samarium-cobalt magnets, NdFeB magnets, and iron oxide magnets. In one embodiment, the magnetically-modified MnO₂ electrode comprises a mixture comprising MnO₂ and SmCo₅.

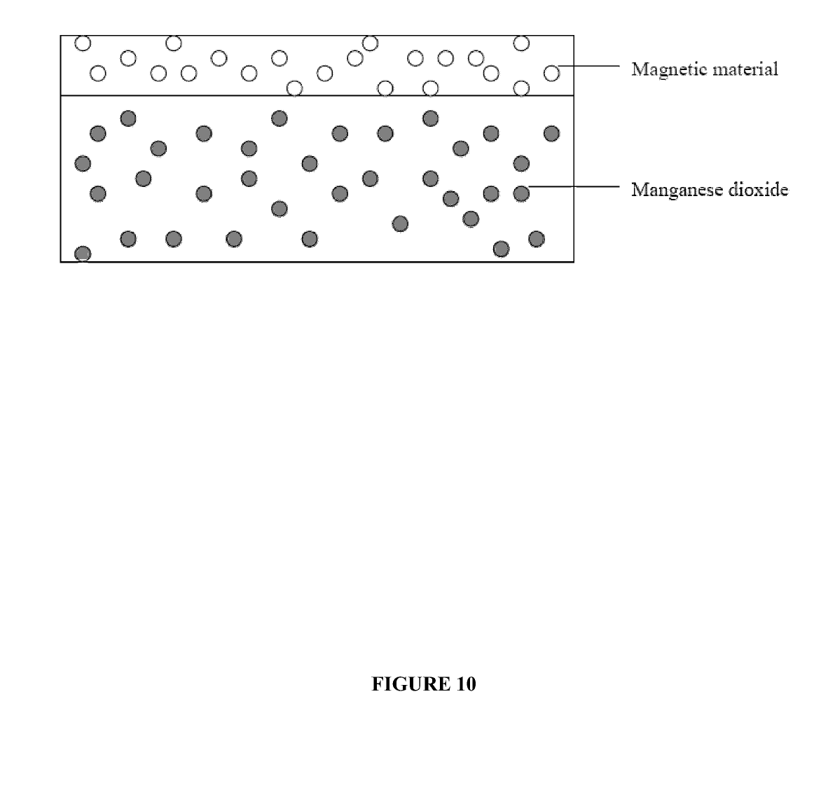

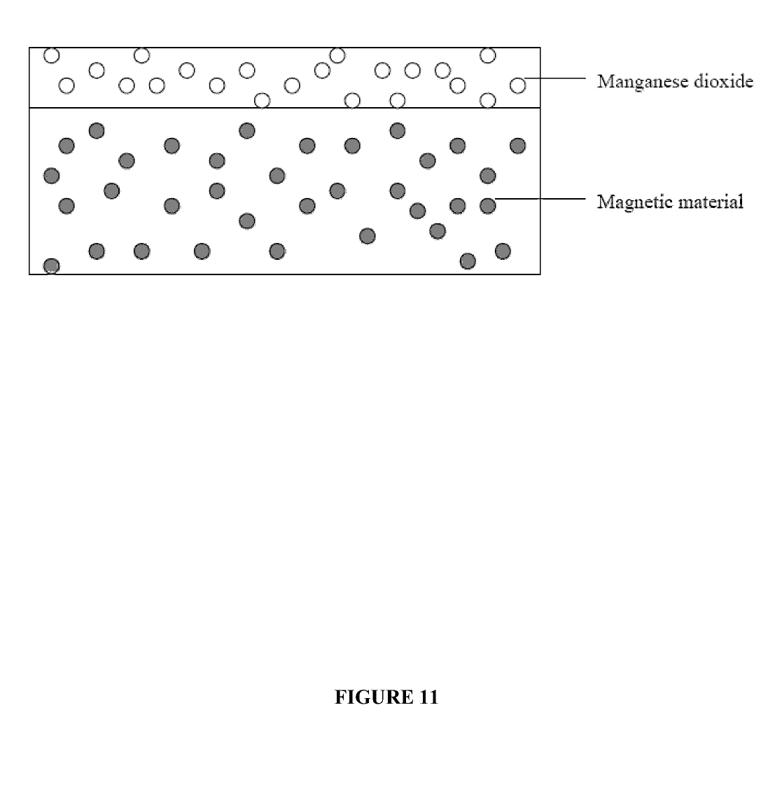

The magnetically-modified MnO₂ electrode described herein can comprise, for example, a MnO₂ substrate and a magnetic coating disposed on the substrate, as shown in FIG. 10. The magnetically-modified MnO₂ electrode can comprise, for example, a magnetic substrate and a MnO₂ coating disposed on the substrate, as shown in FIG. 11.

The magnetically-modified MnO₂ electrode described herein can comprise, for example, a porous substrate comprising MnO₂ and at least one magnetic material embedded within the porous substrate. Porosity allows access to the surface of the manganese dioxide that enables the pseudocapacitance of Equation 1 to be established.

The magnetically-modified MnO₂ electrode described herein can further comprise, for example, at least one binder. The magnetically-modified MnO₂ electrode can comprise a mixture comprising MnO₂, the at least one magnetic material, and the at least one binder. The binder can comprise, for example, a soft, chemically non-reactive material (e.g., polymers and cellulose). The binder can comprise, for example, polytetrafluoroethylene. The binder can comprise, for example, one or more materials selected from polyethylene, cellulose and methyl cellulose.

The magnetically-modified MnO₂ electrode described herein can further comprise, for example, at least one conductor. The magnetically-modified MnO₂ electrode can comprise a mixture comprising MnO₂, the at least one magnetic material, and the at least one conductor. The conductor can comprise, for example, a metal or a carbon-based conductive material. The conductor can comprise, for example, graphite and/or acetylene black. The conductor can comprise, for example, an inert metal or a metal with a conductive oxide.

In some embodiments, the magnetically-modified MnO₂ electrode described herein comprises a mixture comprising MnO₂, at least one magnetic material, at least one binder, and at least one conductor. In a particularly embodiment, the magnetically-modified MnO₂ electrode described herein comprises a mixture comprising MnO₂, SmCo₅, polytetrafluoroethylene, and graphite.

The magnetically-modified MnO₂ electrode described herein can comprise, for example, 40-90 wt. %, or 50-85 wt. %, or 60-85 wt. % of MnO₂. The magnetically-modified MnO₂ electrode described herein can comprise, for example, 1-20 wt. %, or 2-15 wt. %, or 3-10 wt. %, or 5-15% of magnetic material. The magnetically-modified MnO₂ electrode described herein can comprise, for example, 5-40 wt. %, or 10-30 wt. %, or 15-25 wt. % of conductor material. The magnetically-modified MnO₂ electrode described herein can comprise, for example, 1-10 wt. %, or 2-8 wt. %, or 3-7 wt. % of binder material.

In some embodiments, the magnetically-modified MnO₂ electrode is present in the form of a thin film. The thin-film can have a thickness of, for example, about 0.01-1,000 μm, or about 0.1-500 μm, or about 1-200 μm, or about 20-100 μm, or about 200-300 μm, or about 0.2 to 1 μm.

In some embodiments, the aforementioned thin film of the magnetically-modified MnO₂ electrode is incorporated into stable metal-meshes. These meshes can be corrosion resistant (e.g., Ti or Ti-sputtered stainless steel).

Methods for Making and Using the Supercapacitor

The supercapacitor described herein can be made by, for example, incorporating an electrode which is magnetically-modified and comprises MnO₂ as cathode. In some embodiments, the process further comprises incorporating an aqueous electrolyte having a pH of 5-9 in the supercapacitor. In some embodiments, the process further comprises incorporating a counter-electrode comprising carbon-based material in the supercapacitor.

The supercapacitor described herein can be utilized by, for example, charging and discharging the supercapacitor. In some embodiments, MnO₂ is reduced at the surface of the electrode with electrolyte cation neutralization. In some embodiments, no more than 30%, or no more than 20%, or no more than 10%, or no more than 5% of the MnO₂ in the bulk of the electrode is reduced.

In some embodiments, the magnetically-modified MnO₂ electrode is prepared in the presence of an external magnetic field, and the magnetic material is magnetized to sustain a magnetic field. In other embodiments, the magnetically-modified MnO₂ electrode is prepared in the absence of an external magnetic field, and the magnetic material only sustains a residual magnetic field.

### Applications and Devices

The supercapacitor described herein can possess high energy density as well as rapid charging capabilities (which translates to high power density). One exemplary application is in transportation vehicles including automotives including electric vehicles (EV), which demand faster charging than current battery technology allows. Other exemplary applications include heavy transport vehicles, such as railroad locomotives, light-rail vehicles, diesel trucks, buses, tanks and submarines. The supercapacitor described herein can also be used in, for example, computers, personal mobile devices, and network infrastructures.

Additional embodiments are provided in the following non-limiting working examples.

### WORKING EXAMPLES

### Example 1

### Methods and Materials

γ-MnO₂

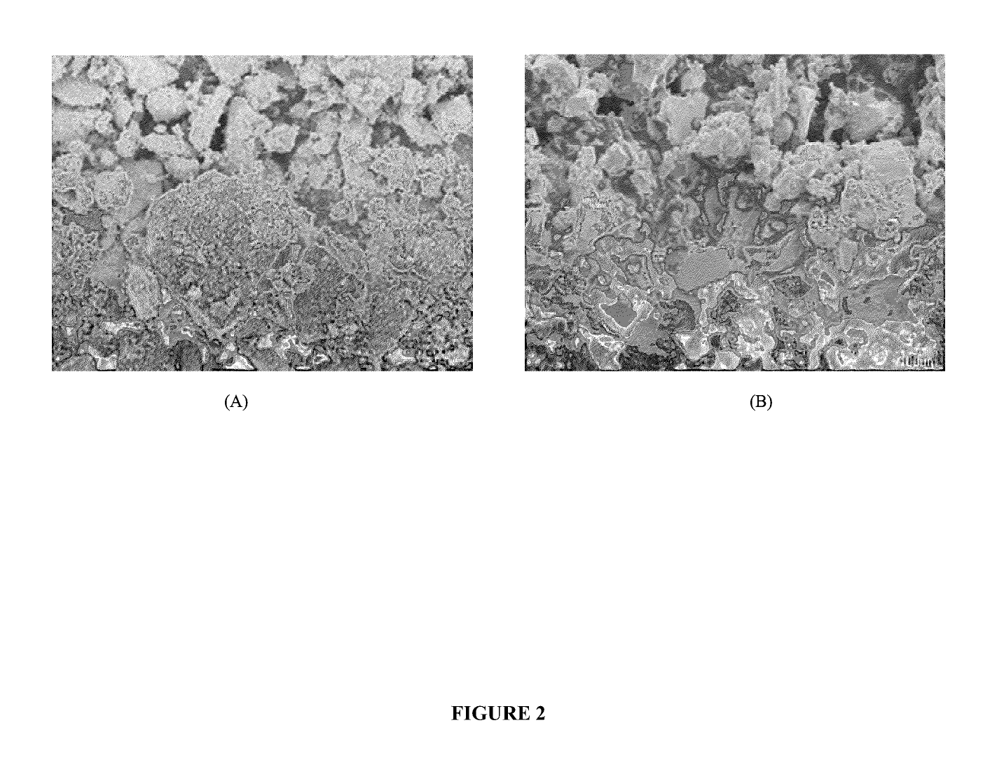

The crystal phase of the MnO₂ was considered. For the results presented herein, γ-MnO₂ was selected for its availability. The γ-MnO₂ (Delta EMD, RSA) used here exists as a random intergrowth of pyrolusite (β-MnO₂) in a ramsdellite matrix. Unprocessed EMD from Delta is shown in a scanning electron micrograph (SEM) image in FIG. 2(A).

Electrode Preparation:

To make MnO₂ electrodes, a mixture of EMD, a binding agent, and graphite were combined and thoroughly mixed. 75% MnO₂ (w/w) was combined with 5% binder (polytetrafluoroethylene (PTFE), Sigma), and 20% graphite (<20 μm, Sigma) for unmodified electrodes. The graphite acted as a conductor in the pellet, where at 20% the electrodes contain sufficient conducting materials (above the percolation coefficient minimum). Magnetically modified electrodes contained microparticles of SmCo₅ (Alfa Aesar). The percentage of SmCo₅ added to the pellet mixture was subtracted from the percentage of MnO₂ in the pellet mixtures (e.g., a 10% SmCo₅ modified system contains 65% MnO₂ (w/w)). The SmCo₅ was added to the mixture as received. Alternatively, the magnetic material can be ball-milled. An SEM of the SmCo₅ is seen in FIG. 2(B).

Electrodes were cold pressed from the pellet mixture, using a pellet dye, into thin films (approximately 200 to 300 μm thick) at 2.5 tons/sq. inch. (These pellets were approximately 3 to 10 times thicker that literature films, which was reflected in increased internal-resistance.) The pellets ranged in mass from 30 to 45 mg. The amount of active material in the pellets was accounted for when considering specific capacitance of the system Thinner films would yield higher pseudocapacitance.

Testing Setup:

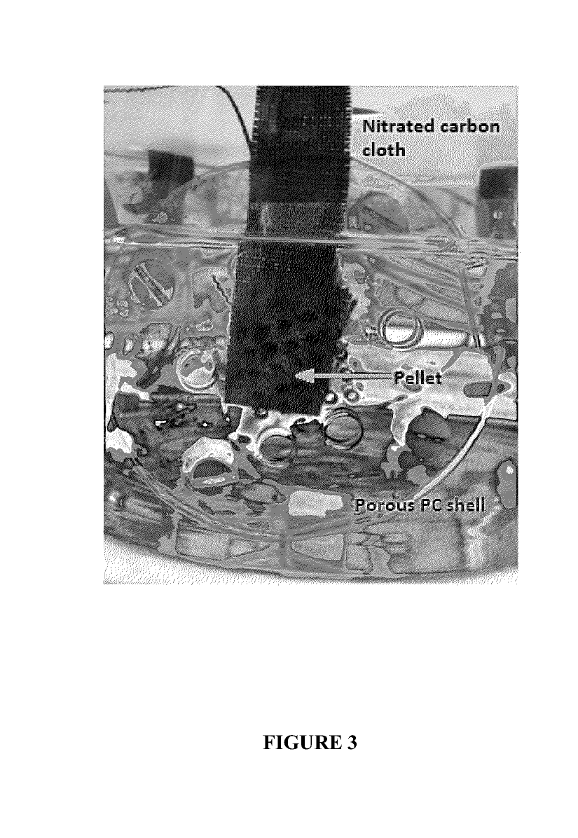

Electrodes were tested in an electrochemical setup using a CHI 760B potentiostat/galvanostat. The pellets were placed in a nitrated carbon cloth that acted as the current collector. The pellet/cloth complex was sandwiched between two polycarbonate plates to ensure connectivity—the pressure of the plates was not considered. The setup is pictured in FIG. 3. Ag|AgCl was used as the reference electrode, and platinum mesh was used as the counter electrode. This system was tested as a half-cell. A 0.1M CaCl₂ solution was used as the supporting electrolyte throughout this study. Chronopotentiometry, a constant current measurement, was used to evaluate the cells over a variety of current loads. In addition, a CHI Instruments multiplexer allowed for the automated evaluation of up to eight individual electrodes.

Electrochemical Evaluation:

Chronopotentiometry, a galvanostatic measurement, is the principal method used to evaluate the electrodes herein. In chronopotentiometry, a constant current is applied to the electrode, and the potential (V) varies as a function of time.

This is given in Equation 2:

$$E = \text{?} {R}_{s} + \frac{\text{?}}{C} \text{?} d t \\ \text{?} \text{indicates text missing or illegible when filed} \qquad [ 2 ]$$

The electrodes were tested over a variety of absolute currents: 1 mA, 2.5 mA, 4 mA, and 5 mA. These currents were chosen based upon the pellet electrode dimensions. At 200 to 300 μm in thickness, considerable internal resistance, or Ohmic resistance, was present. At high current loads (>10 mA) the magnitude of the Ohmic drop was substantial. In literature, thin films of MnO₂ (<100 μm) were prepared on metal (e.g., Ti) grids and that helped reduce Ohmic drop. However, the magnetic field effects observed and reported here are likely not dependent upon pellet architecture. In other words, magnetic field effects are anticipated to exist in both thin films (˜100 to 200 μm) as in the present pellet system.

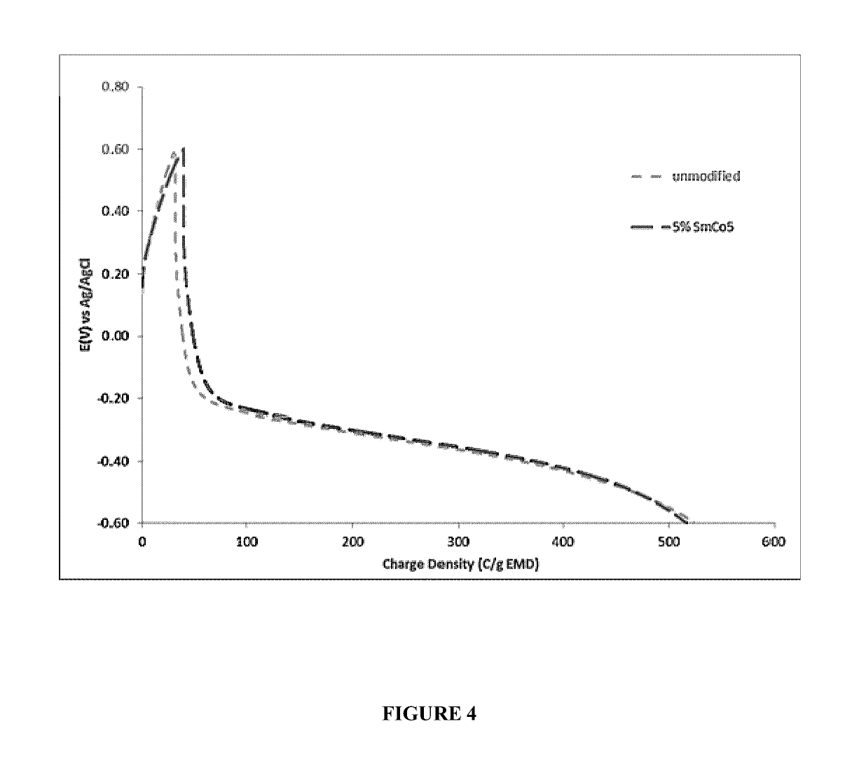

A complete discharge to −0.6V (vs. Ag|AgCl) for one cycle is shown in FIG. 4. Pseudocapacitance was extracted from the region between 0.6 and −0.2 V. A typical discharge is shown in FIG. 4, with the x-axis in the discharge curve being charge density. Charge density in coulombs/gram active material was converted from discharge time via Equation 3:

$$Charge Desity C {\text{?}}^{\text{?}} = \frac{time ( s ) \times current ( A )}{mass EMD ( \text{?} )} \\ \text{?} \text{indicates text missing or illegible when filed} \qquad [ 3 ]$$

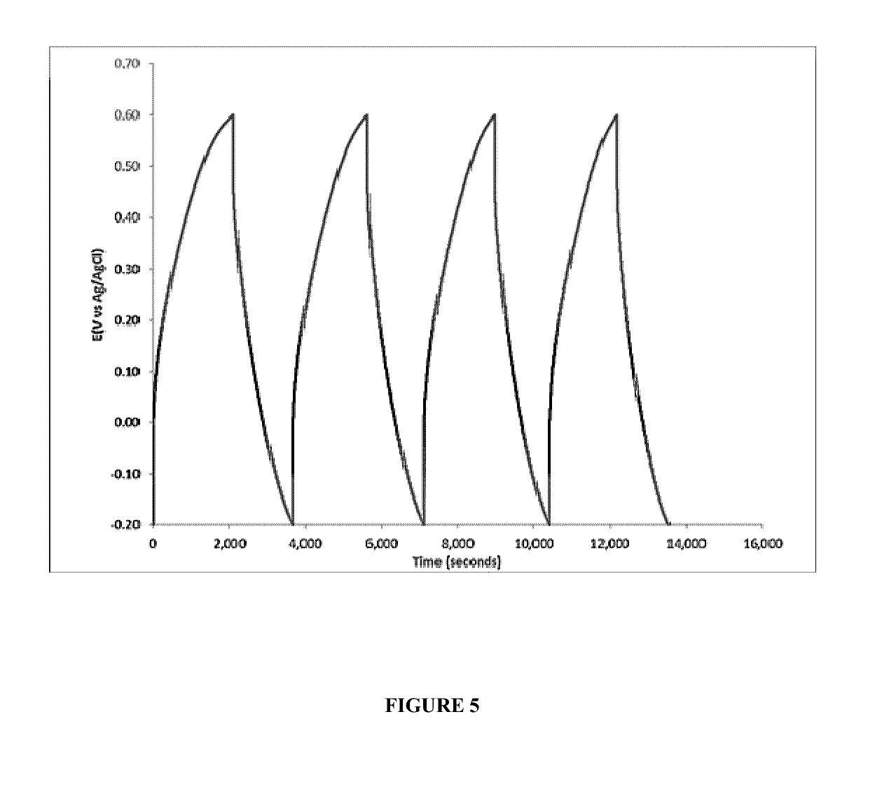

Capacitance enhancement was measured in the slope of charging/discharging over the region between 0.6 and −0.2 V. A typical saw-tooth graph of this charging/discharging is shown in FIG. 5.

Capacitance was measured from the linear region between 0.6 and −0.2 V vs. a Ag|AgCl reference electrode. The capacitance was calculated from Equation 2, where capacitance (C) was calculated via the slope (m) of derived potential (E) with time (t) from a constant current step, in Equation 4:

$$= \text{?} {R}_{s} + \frac{\text{?}}{C} \text{?} d t = C = \frac{\text{?}}{\frac{d \text{?}}{d t}} = \frac{\text{?}}{m} \\ \text{?} \text{indicates text missing or illegible when filed} \qquad [ 4 ]$$

Where dE/dt was the slope of the discharge, i(A) was the current in amps, and capacitance was measured in farads, F. The capacitance was then normalized for the amount of active material to specific capacitance, i.e., F/g EMD.

### Example 2

### Results

Effect of Magnetic Modification on Internal Resistance:

To determine if a difference in internal resistance, or Ohmic resistance, existed between modified and unmodified pellets, we evaluated the magnitude of iR-drop of a series of pellets with and without magnets.

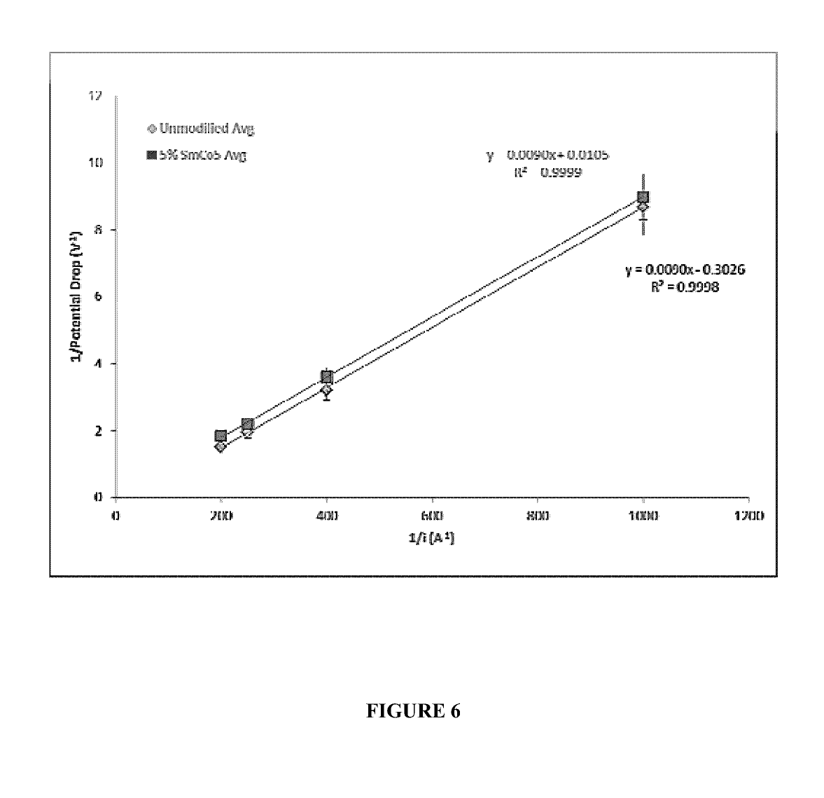

As seen from the data in FIG. 6, magnetic microparticles of SmCo₅ did not significantly lower Ohmic resistance. To extract resistance from the following data, Ohm's law was applied:

V=iR [5]

Where voltage, V, is equal to the sum of current, i, times resistance, R. From [5], equation [6] was obtained.

$$R = \frac{V}{i} \qquad [ 6 ]$$

The inverse of Equation [6] was used to extract resistance from a plot of average voltage drop versus applied current. Table 1 gives the values of 1/E-drop (V) and 1/i (A) that were used to produce the double reciprocal plot in FIG. 6.

TABLE 1
Values of potential drop for modified and unmodified electrodes.

| | | E-drop | 1/E-drop | E-drop | 1/E-drop |
|---|---|---|---|---|---|
| | | (V) | (V⁻¹) | (V) | (V⁻¹) |
| Current | 1/i | (0% | (0% | (5% | (5% |
| (mA) | (A) | SmCo₅) | SmCo₅) | SmCo₅) | SmCo₅) |
| 1 | 1000 | 0.115 (±5%) | 8.69 (±5%) | 0.112 (±9%) | 8.99 (±9%) |
| 2.5 | 400 | 0.313 (±12%) | 3.22 (±12%) | 0.279 (±8%) | 3.59 (±8%) |
| 4 | 250 | 0.515 (±11%) | 1.95 (±1%) | 0.451 (±5%) | 2.22 (±5%) |
| 5 | 200 | 0.659 (±11%) | 1.53 (±11%) | 0.544 (±8%) | 1.84 (±8%) |

Using the form y=mx+b, the slope m is equivalent to R⁻¹, therefore resistance is the inverse of the slope, m⁻¹. The slope for both modified and unmodified pellets was 9.0×10⁻³, this returned a resistance of 110Ω for each pellet type—no significant difference is observed. However, it is interesting to note that the intercepts at i⁻¹=0 differ by a value of 0.29 V⁻¹ such that there is an inherent lower resistance in the magnetically modified electrodes that may be ascribed to the better pseudocapacitance with magnetic modification.

Measurements of Pseudocapacitance at Varying Current Densities:

Two main sets of experiments were performed and analyzed: (i) the effects of current-demands on electrode capacitance, and (ii) the effects of magnetic particle loading content. 5% SmCo₅ (w/w) modified electrodes were used to illustrate the effects on varying current demands. This was followed by an analysis of magnetic particle loading optimization.

Current Demand Analysis:

To establish enhancements in pseudocapacitance of powder based EMD pellets modified with 5% SmCO₅, measurements at a variety of current densities were performed. The upper end of these measurements was 5 mA, which translates to approximately 0.2 A/g EMD. This value is an order of magnitude less than literature testing values. However, the physical limitations, such as film thickness, described in the previous section establish this upper limit.

Pseudocapacitance was measured in the linear region of the discharge cycle. Due to Ohmic resistance, the potential range was adjusted to maintain a linear region for calculations. The linear region was determined by an R² (correlation coefficient) value between approximately 0.95 and 0.98. (Ideally, R² is at or near 1.)

The cumulative analysis for 1 mA cycling, for number of samples n=9, is shown in Table 2. At 1 mA charging/discharging currents, the electrodes were evaluated between 0.45 and −0.2 V vs. Ag|AgCl. For eight degrees of freedom (n−1), the normalized capacitance of the two sets of electrodes was different at the 90% CL. The modified electrodes showed an increased normalized capacitance of 22.6% versus unmodified electrodes. Additionally, the modified electrodes had a greater Coulombic efficiency (time charging/time discharging) than unmodified electrodes.

TABLE 2
Statistical Evaluation for 1 mA
chronopotentiometric cycling (relative increase
of modified versus unmodified)

| | | | | |
|---|---|---|---|---|
| | | | Capaci- | Coulom- |
| | | Capacitance | tance | bic Effi- |
| Electrode | Slope | (F) | (F/g) | ciency |

Unmodified electrodes

| | | | | |
|---|---|---|---|---|
| Average | 7.43 × 10⁻⁴ | 1.52 | 50.8 | 0.70 |
| Std. | 3.37 × 10⁻⁴ | 4.26 × 10⁻¹ | 12.3 | 0.19 |
| deviation | 45 | 28 | 24 | 27 |
| Rel. | | | | |
| stdev. (%) | | | | |

5% SmCo₅ modified electrodes

| | | | | |
|---|---|---|---|---|
| Average | 6.14 × 10⁻⁴ | 1.67 | 58.9 | 0.79 |
| Std. | 1.05 × 10⁻⁴ | 2.71 × 10⁻¹ | 6.48 | 0.08 |
| deviation | 17 | 16 | 11 | 9 |
| Rel. | | T_{calc} | 2.249 | 1.045 |
| stdev. (%) | | S_{pooled} | 10.238 | 0.145 |
| | | Rel. | 16% | 13.69% |
| | | Increase | | |

At 2.5 mA cycling current the results are shown in Table 3. For eight degrees of freedom (n−1), the normalized capacitance of the two sets of electrodes was different at the 95% CL. The normalized capacitance of modified electrodes was near 30% greater than unmodified electrodes.

TABLE 3
Statistical Evaluation for 4 mA
chronopotentiometric cycling (relative increase
of modified versus unmodified)

| | | | | |
|---|---|---|---|---|
| | | Capacitance | Capacitance | Coulombic |
| Electrode | Slope | (F) | (F/g) | Efficiency |

Unmodified electrodes

| | | | | |
|---|---|---|---|---|
| Average | 3.84 × 10⁻³ | 0.729 | 25.41 | 0.85 |
| Std. | 1.5 × 10⁻³ | 0.25 | 8.2 | 0.09 |
| deviation | 38 | 34 | 32 | 11 |
| Rel. | | | | |
| stdev. (%) | | | | |

5% SmCo₅ modified electrodes

| | | | | |
|---|---|---|---|---|
| Average | 2.76 × 10⁻³ | 0.935 | 33.01 | 0.87 |
| Std. | 5.2 × 10⁻⁴ | 0.18 | 4.7 | 0.02 |
| deviation | 19 | 19 | 14 | 3 |
| Rel. | | T_{calc} | 2.417 | 0.419 |
| stdev. (%) | | S_{pooled} | 6.670 | 0.069 |
| | | Rel. Increase | 29.9% | 2.2% |

Table 4 gives the results for cycling at 4 mA. At higher currents, the linear region was reduced, now only covering a range of 250 mV (internal resistance manifests at i(A)>3 mA). The reliability of the measurement is based upon only five degrees of freedom, and this leads to a decrease in the CL to 50%. The relative increase in normalized capacitance is 31%. This trend in increased normalized capacitance is further observed at 5 mA.

TABLE 4
Statistical Evaluation for 4 mA
chronopotentiometric cycling (relative increase
of modified versus unmodified)

| | | | | |
|---|---|---|---|---|
| | | Capacitance | Capacitance | Coulombic |
| Electrode | Slope | (F) | (F/g) | Efficiency |

Unmodified electrodes

| | | | | |
|---|---|---|---|---|
| Average | 2.01 × 10⁻² | 0.315 | 10.82 | 0.79 |
| Std. | 1.7 × 10⁻² | 0.19 | 6.6 | 0.1 |
| deviation | 84 | 60 | 61 | 18 |
| Rel. | | | | |
| stdev. (%) | | | | |

5% SmCo₅ modified electrodes

| | | | | |
|---|---|---|---|---|
| Average | 1.13 × 10⁻² | 0.414 | 14.20 | 0.81 |
| Std. | 4.9 × 10⁻³ | 0.17 | 5.8 | 0.07 |
| deviation | 43 | 42 | 41 | 9 |
| Rel. | | T_{calc} | 0.943 | 0.369 |
| stdev. (%) | | S_{pooled} | 6.225 | 0.114 |
| | | Rel. Increase | 31.3% | 3.39% |

Table 5 gives the results for 5 mA cycling—the same linear range as used in the 4 mA cycling. Again, for five degrees of freedom, the measurements were different at the 50% CL. However, normalized capacitance was 73% greater for modified electrodes. Throughout, performance increases with magnetic modification and relative enhancements are more apparent at higher current.

Also observed is the greatest increase in Coulombic efficiency enhancement for modified electrodes at 5 mA discharge currents. As these electrodes are primarily utilized in high power applications, the impact of magnetic field effects on electrode kinetics was substantial. That is, because supercapacitors are high power devices, improving the ability of the device to be quickly cycled at higher pseudocapcitance yields improved performance.

TABLE 5
Statistical Evaluation for 5 mA chronopotentiometric
cycling (relative increase of modified versus unmodified)

| | | | | |
|---|---|---|---|---|
| | | Capacitance | Capacitance | Coulombic |
| Electrode | Slope | (F) | (F/g) | Efficiency |

Unmodified electrodes

| | | | | |
|---|---|---|---|---|
| Average | 1.61 × 10⁻¹ | 0.085 | 2.93 | 0.30 |
| Std. | 1.1 × 10⁻¹ | 0.09 | 3_{•3} | 0.08 |
| deviation | | | | |
| Rel. stdev. (%) | 70 | 114 | 113 | 26 |

5% SmCo₅ modified electrodes

| | | | | |
|---|---|---|---|---|
| Average | 4.4 × 10⁻² | 0.145 | 5.075 | 0.54 |
| Std. | 1.9 × 10⁻² | 0.09 | 3.1 | 0.07 |
| deviation | | | | |
| Rel. stdev. (%) | 42 | 66 | 61 | 13 |
| | | T_{calc} | 1.153 | 5.131 |
| | | S_{pooled} | 3.218 | 0.074 |
| | | Rel. | 72.9% | 79.7% |
| | | Increase | | |

Optimized Magnetic Loadings:

The impact of loading was investigated, based on mass percentage EMD, between 5 and 15% (w/w) at 5% increments. The previously described current analysis for 5% loadings were performed at 10 and 15% loadings as well, however for brevity, all data are not included in the following:

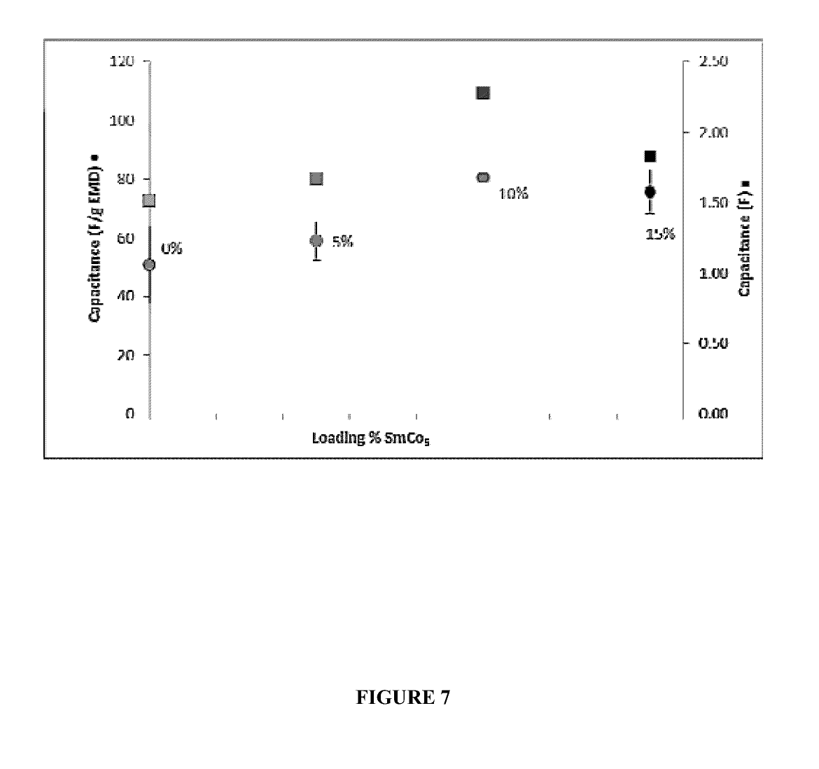

FIG. 7 is a plot of capacitance versus loadings of SmCo₅ at 1 mA. The left y-axis is normalized capacitance for active material (i.e., capacitance/g EMD); the right y-axis is non-normalized capacitance (F). The error bars are for relative standard deviation (approximate relative standard deviations are the same for absolute capacitance).

It can be seen that loadings were optimized at approximately 10% SmCo₅ (w/w). In addition to realizing ideal magnetic loadings, this set of experiments revealed that the SmCo₅ was not adding to capacitance through additional charge storage on the magnetic particles. Rather capacitance was increased through the traditional enhancement of ET reaction kinetics observed in other electrochemical power systems. Also, it can be seen from the data that both normalized and absolute capacitance were increased in the modified systems.

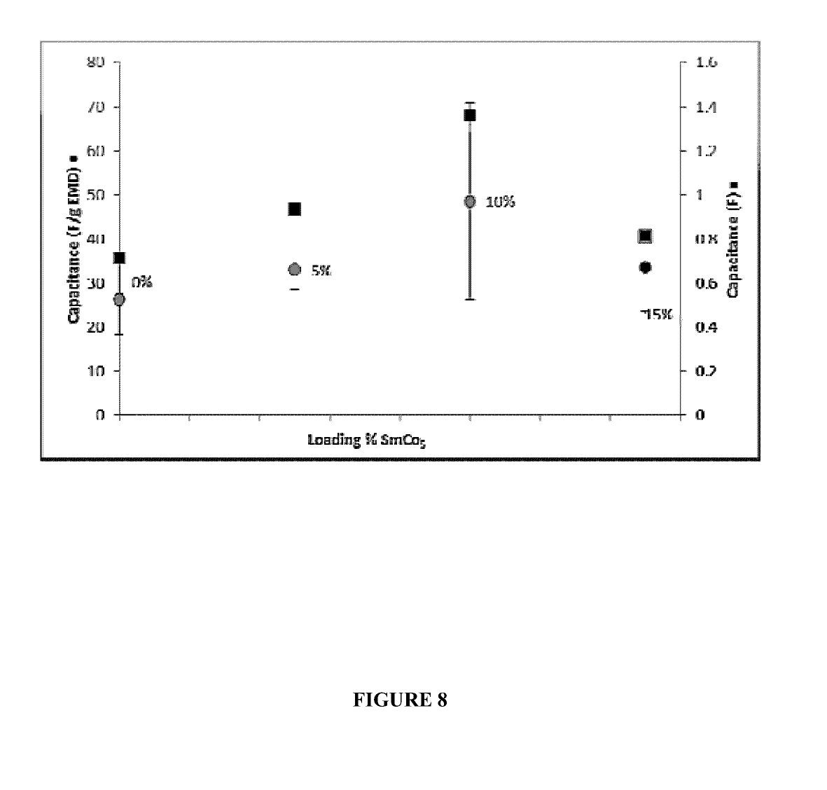

The optimized loadings were seen over the range of current densities tested. FIG. 8 shows optimization at 2.5 mA charging/discharging currents. The relative error for 10% loadings was 46%, a value that resulted from an electrode with unusually high capacitance; a value that could not be removed from the data set through either a Q-test or Grubb's test.

The results for loading optimization can be seen in Table 6. The values given are for 1 mA, and include capacitance (F), specific capacitance (F/g MnO₂), relative standard deviations, relative enhanced capacitance values, and statistical relevance.

TABLE 6
Results of magnetic loading optimizations, values of capacitance at 1 mA absolute
currents (CL = confidence level)

| | Capacitance | Rel. | % | Capacitance | Rel. | % | Diff @ |
|---|---|---|---|---|---|---|---|
| Loading | (F) | Stdev. | Enhancement | (F/g) | Stdev. | Enhancement | CL |
| 0% | 1.52 | 28 | | 50.85 | 26 | | |
| (control) | | | | | | | |
| 5% | 1.67 | 16 | 10 | 58.95 | 11 | 16 | 90% |
| SmCo₅ | | | | | | | |
| 10% | 2.28 | 23 | 50 | 80.56 | 22 | 58 | 98% |
| SmCo₅ | | | | | | | |
| 15% | 1.83 | 10 | 20 | 75.73 | 11 | 49 | 99% |
| SmCo₅ | | | | | | | |

### CONCLUSIONS

Statistically relevant enhancements in absolute capacitance (F) and specific normalized capacitance (F/g MnO2) for MnO₂ electrodes magnetically modified with SmCo₅ microparticles was observed. The enhancements were observed at all magnetic loadings, but have been maximized in electrodes containing ca. 10% SmCo₅ (w/w), with enhancement in specific capacitance at 58% versus unmodified electrodes, statistically validated at the 98% CL at 1 mA absolute charging/discharging currents. At low charging/discharging currents, the enhancement for 5% SmCo₅ loadings was less pronounced (16% at 1 mA and 30% at 2.5 mA); however, these cycling currents resulted in less Ohmic drop and greater statistical significance. As absolute cycling currents increase (≧5 mA), a general decrease in capacitance was observed in both control and modified systems; however, more importantly an increase in Coulombic efficiency was observed in the modified system, an important result for these high power systems.

What is claimed is:

1. A device comprising a supercapacitor, said supercapacitor comprising an electrode, wherein the electrode is magnetically-modified and comprises MnO₂.

2. The device of claim 1, wherein the supercapacitor is an asymmetric supercapacitor.

3. The device of claim 1, wherein the supercapacitor is an asymmetric supercapacitor comprising said electrode as cathode.

4. The device of claim 1, wherein the supercapacitor is an asymmetric supercapacitor comprising said electrode as cathode, and wherein said electrode is in contact with an aqueous electrolyte having a pH of 5-9.

5. The device of claim 1, wherein the supercapacitor is an asymmetric supercapacitor comprising said electrode as cathode, and wherein said electrode is in contact with an aqueous electrolyte selected from CaCl₂, KCl, K₂SO₄, and NaCl.

6. The device of claim 1, wherein the supercapacitor is an asymmetric supercapacitor comprising said electrode as cathode, and wherein said electrode is in contact with a non-aqueous electrolyte.

7. The device of claim 1, wherein the supercapacitor is an asymmetric supercapacitor comprising a counter electrode which comprises carbon-based material.

8. The device of claim 1, wherein said MnO₂ is selected from γ-MnO₂, β-MnO₂, α-MnO₂, and a mixture thereof.

9. The device of claim 1, wherein the electrode comprises a mixture comprising MnO₂ and at least one magnetic material.

10. The device of claim 1, wherein the electrode comprises a mixture comprising MnO₂ and at least one magnetic material, wherein said magnetic material comprises SmCo₅.

11. The device of claim 1, wherein the electrode comprises a mixture comprising MnO₂, at least one magnetic material, and at least one binder.

12. The device of claim 1, wherein the electrode comprises a mixture comprising MnO₂, at least one magnetic material, and at least one binder, and wherein said binder comprises polytetrafluoroethylene.

13. The device of claim 1, wherein the electrode comprises a mixture comprising MnO₂, at least one magnetic material, and at least one conductor.

14. The device of claim 1, wherein the electrode comprises a mixture comprising MnO₂, at least one magnetic material, and at least one conductor, and wherein said conductor comprises graphite.

15. The device of claim 1, wherein the electrode comprises a mixture comprising MnO₂, at least one magnetic material, at least one binder, and at least one conductor.

16. The device of claim 1, wherein the electrode comprises a mixture comprising MnO₂, SmCo₅, polytetrafluoroethylene, and graphite.

17. The device of claim 1, wherein the electrode comprises 50-75 wt. % of MnO₂.

18. The device of claim 1, wherein the electrode comprises 1-20 wt. % of a magnetic material.

19. The device of claim 1, wherein the electrode further comprises 10-30 wt. % of a conductive material.

20. The device of claim 1, wherein the electrode further comprises 0.5-10 wt. % of a binder material.

21. The device of claim 1, wherein the magnetically modified MnO₂ is present in the form of a thin film having a thickness of 0.1-500 μm.

22. The device of claim 1, wherein the magnetically modified MnO₂ is present in the form of a thin film having a thickness of 0.2-100 μm.

23. The device of claim 1, wherein the supercapacitor has an increase in capacitance of at least 10%, compared to a control supercapacitor comprising an electrode that comprises an analogous MnO₂ composition except there are no magnetic additives.

24. The device of claim 1, wherein the supercapacitor has an increase in capacitance of at least 30%, compared to a control supercapacitor comprising an electrode that comprises an analogous MnO₂ composition except there are no magnetic additives.

25. The device of claim 1, wherein the supercapacitor does not comprise aqueous KOH as electrolyte.

26. A method for making the device of claim 1, comprising incorporating an electrode that is magnetically-modified and comprises MnO₂ as cathode.

27. The method of claim 26, further comprising incorporating an aqueous electrolyte having a pH of 5-9.

28. A method for using the device of claim 1, comprising charging and discharging the supercapacitor.

29. The method of claim 28, wherein the MnO₂ is reduced at the surface of the electrode with electrolyte cation neutralization during charging and returns to MnO₂ during the discharge cycle.

30. The method of claim 28, wherein no more than 10% of the MnO₂ in the bulk of the electrode is reduced.

31. A device comprising a supercapacitor, said supercapacitor (a) comprising a magnetically-modified electrode, and (b) having a capacitance of at least 10% higher than a control supercapacitor comprising an electrode that is not magnetically-modified.

32. The device of claim 31, wherein the magnetically modified electrode comprises MnO₂.
